(19) United States
(12) Patent Application Publication
(10) Pub. No.: US 2006/0172699 A1
(43) Pub. Date: Aug. 3, 2006

(54) Positioning system and method for positioning wireless terminals

(76) Inventor: Takashi Goto, Tokyo (JP)

Correspondence Address: RABIN & Berdo, PC, 1101 14TH STREET, NW, SUITE 500, WASHINGTON, DC, 20005, US

(21) Appl. No.: 11/046,941

(22) Filed: Feb. 1, 2005

(51) Int. Cl. H04B 7/15

(52) U.S. Cl. 455/11.1; 455/456.1

(57) ABSTRACT

According to the present invention, a relative positioning system includes: a plurality of wireless terminals, which are capable to communicate to each other over a mesh network; and a reference station having an absolute position information. Each of the plurality of wireless terminals calculates its position information using the absolute position information of the reference station; stores the position information thereof; and shares the position information with other wireless terminals each other.

### TECHNICAL FIELD OF THE INVENTION

The present invention relates generally to a relative positioning system in a mesh network, and more specifically to positioning determination enhancements to wireless terminals in a mesh network.

### BACKGROUND OF THE INVENTION

Devices with local frequency oscillators have been used in many applications, ranging from cellular phones to television tuners to wireless local area networks (WLAN) or wireless personal area networks that implement various standardized protocols, e.g., IEEE802.15, IEEE 802.11 a/b, HiperLAN2 or “Zigbee”. In recent years, mesh networks are becoming well known and widely used.

GPS and A-GPS are major technology used for relative positioning of vehicles and cellular phones. Positioning and data communication can be performed among a plurality of wireless terminals.

GPS is difficult to be applied to an in-building positioning system, because radio signals may be interrupted or disconnected in a building. Further, such a system requires a large amount of introduction cost to establish it.

### OBJECTS OF THE INVENTION

Accordingly, it is an object of the present invention to provide a simple system for relative positioning of wireless terminals over a mesh network.

Additional objects, advantages and novel features of the present invention will be set forth in part in the description that follows, and in part will become apparent to those skilled in the art upon examination of the following or may be learned by practice of the invention. The objects and advantages of the invention may be realized and attained by means of the instrumentalities and combinations particularly pointed out in the appended claims.

### SUMMARY OF THE INVENTION

According to a first aspect of the present invention, a relative positioning system includes: a plurality of wireless terminals, which are capable to communicate to each other over a mesh network; and a reference station having an absolute position information. Each of the plurality of wireless terminals calculates its position information using the absolute position information of the reference station; stores the position information thereof; and shares the position information with other wireless terminals each other.

According to a second aspect of the present invention, a method for positioning wireless terminals in a mesh network, comprising the steps of:

providing a reference station having an absolute position information;

providing a plurality of wireless terminals, which are capable to communicate each other over a mesh network;

calculating position information of each wireless terminal using the absolute position information of the reference station; storing the position information in each wireless terminal; and

sharing the position information among the plurality of wireless terminals.

Preferably, the position information of each of the plurality of wireless terminal is updated. The plurality of wireless terminals may include a plurality of wireless routers, which may be fixed in location.

The position information of each wireless terminal may be calculated by triangulation method using distance information to adjacent two locations selected from those of other wireless terminals and the reference station. The distance information may be calculated in accordance with propagation loss of radio signals. The propagation loss may be calculated based on an ED (Energy Detect) value, which is a time-mean value of received signal strength.

Preferably, each of the plurality of wireless terminals measures its output power and transmits the measured output power to other wireless terminals, and each of the plurality of wireless terminals compensates a received signal strength in accordance with the output power transmitted from other wireless terminals.

### BRIEF DESCRIPTION OF THE DRAWINGS

FIG. 1 is a conceptual diagram showing a relative positioning system according to a preferred embodiment of the present invention.

FIG. 2 is a block diagram illustrating a wireless terminal according to a preferred embodiment of the present invention.

### DETAILED DISCLOSURE OF THE INVENTION

In the following detailed description of the preferred embodiments, reference is made to the accompanying drawings which form a part hereof, and in which is shown by way of illustration specific preferred embodiments in which the inventions may be practiced. These preferred embodiments are described in sufficient detail to enable those skilled in the art to practice the invention, and it is to be understood that other preferred embodiments may be utilized and that logical, mechanical and electrical changes may be made without departing from the spirit and scope of the present inventions. The following detailed description is, therefore, not to be taken in a limiting sense, and scope of the present inventions is defined only by the appended claims.

A system according to the present invention is capable, for example, to determine locations of products carried or conveyed in a manufacturing process, or locations of patients in a hospital. According to “Zigbee”, wireless terminals communicate each other via access points, which are fixed in location. According to our system, wireless terminals may be designed to communicate each other directly without via access points.

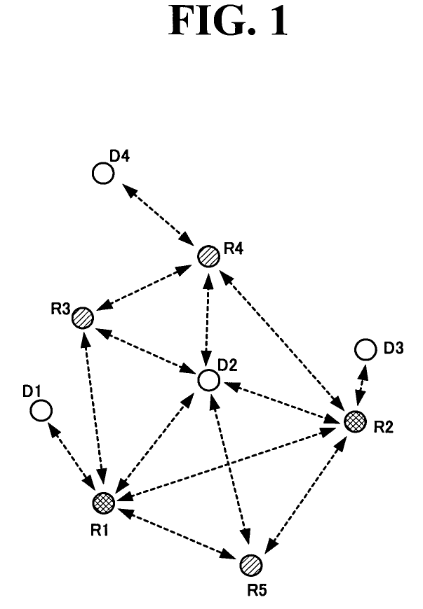

FIG. 1 is a conceptual diagram showing a relative positioning system according to a preferred embodiment of the present invention. A relative positioning system of the embodiment includes: a plurality of wireless terminals D1-D4 and R3-R5, which are capable to communicate to each other over a mesh network; and reference stations R1 and R2 each having its absolute position information. The wireless terminals include end devices D1-D4 and wireless routers R3-R5, which may be fixed in location.

Each of the plurality of wireless terminals D1-D4 calculates its position information using the absolute position information of the reference stations R1 and R2. Each of the plurality of wireless terminals D1-D4 stores its position information and shares the position information with other wireless terminals (D1-D4) each other. The position information of each of the plurality of wireless terminals D1-D4 is updated.

The position information of each wireless terminal is calculated by triangulation method using distance information to adjacent two locations selected from those of other wireless terminals D1-D4 and reference stations R1-R5. The distance information may be calculated in accordance with propagation loss of radio signals. The propagation loss may be calculated based on an ED (Energy Detect) value, which is a time-mean value of received signal strength.

A value L(db), which is the difference between transmission power and ED value, is approximated according to the following formula of propagation loss:
L[dB]=32.4375+20*log10(f)+20*log10(d/1000)

Frequency “f”=(MHz)

Distance “d”=(m)

In FIG. 1, each of the points D1-D4 and R1-R5 calculate its position or location by triangulation method using distance information to adjacent two points. In addition, the position information of each point (D1-D4 and R1-R5) is updated at predetermined timings. For example, the position of the wireless terminal D2 is approximated based on distances to the reference stations R1 and R2. The position information of D2 is transmitted to wireless router R3. The position of the wireless router R3 is approximated based on distances to the wireless station R3 and reference station R1. Thus described operation is repeated to obtain position information of each point (D1-D4 and R1-R5). The wireless terminals D1-D4, wireless routers R3-R5 and reference station R1 and R2 share the position information of the other points.

If the wireless terminal D2 is moving, currently calculated position information based on the location of the points R1 and R4 would be different from the position information that has been calculated based on the location of the points R1 and R2. The position information of the wireless terminal D2 is now updated or rewritten by the updated information. The same operation and function is performed and repeated to every point, so that each point has the current and correct position information.

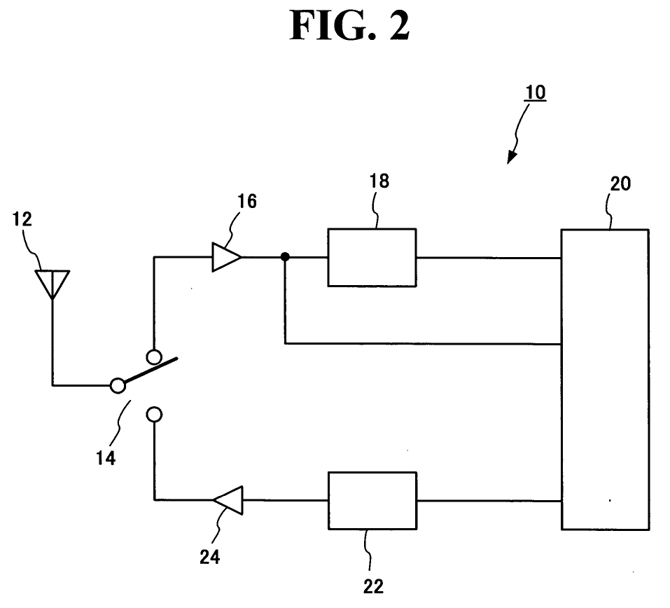

FIG. 2 is a block diagram illustrating a wireless terminal according to a preferred embodiment of the present invention. A wireless terminal 10 is applicable to the wireless terminals D1-D4, shown in FIG. 1. The wireless terminal 10 includes an antenna 12, a switch circuit 14, amplifiers 16 and 24, a demodulator 18, a modulator 22 and a controller 20.

In a receiving mode, a transmitted data signal is supplied to the amplifier 16 through the antenna 12 and switch circuit 14. The received data signal is amplified by the amplifier 16 and supplied to the controller 20 via the demodulator 18. A part of an output signal of the amplifier 16 is picked up or sampled as an ED value by the controller 20. The ED value is used to calculate a distance to the terminal that transmitted the signal according to the above-described method.

In a transmitting mode, a transmitted data signal is supplied from the controller to the amplifier 16 through the modulator 22. An output signal of the modulator 22 is amplified by the amplifier 24 and is transmitted outwardly through the switch circuit 14 and antenna 12.

Preferably, each of the plurality of wireless terminals D1-D4 and the other terminals R1-R5 measures its output power and transmits the measured output power to other wireless terminals D1-D4 and R1-R5. Each of the plurality of wireless terminals D1-D4 and R1-R5 compensates received signal strength in accordance with the output power transmitted from other wireless terminals D1-D4 and R1-R5 to improve the accuracy of calculation of position and distance information.

As described above, according to the present invention, the position information of wireless terminals are easily calculated even in a building. Further, the system according to the present invention can be established a smaller amount of introduction cost. In addition, the power consumption may be reduces.

What is claimed is:

1. A relative positioning system, comprising:
a plurality of wireless terminals, which are capable to communicate to each other over a mesh network; and
a reference station having an absolute position information, wherein
each of the plurality of wireless terminals calculates its position information using the absolute position information of the reference station; stores the position information thereof; and shares the position information with other wireless terminals each other.

2. A relative positioning system according to claim 1, wherein the position information of each of the plurality of wireless terminal is capable to be updated.

3. A relative positioning system according to claim 1, wherein,
the plurality of wireless terminals comprise a plurality of wireless routers.

4. A relative positioning system according to claim 1, wherein
the position information of each wireless terminal is calculated by triangulation method using distance information to adjacent two locations selected from those of other wireless terminals and the reference station.

5. A relative positioning system according to claim 4, wherein
the distance information is calculated in accordance with propagation loss of radio signals.

6. A relative positioning system according to claim 5, wherein
the propagation loss is calculated based on an ED (Energy Detect) value, which is a time-mean value of received signal strength.

7. A relative positioning system according to claim 5, wherein
each of the plurality of wireless terminals measures its output power and transmits the measured output power to other wireless terminals, and
each of the plurality of wireless terminals compensates a received signal strength in accordance with the output power transmitted from other wireless terminals.

8. A relative positioning system according to claim 1, wherein the mesh network is of Zigbee.

9. A wireless terminal, used in a relative positioning system according to claim 1.

10. A wireless terminal according to claim 9, wherein
the position information of each wireless terminal is capable to be updated.

11. A wireless terminal according to claim 10, wherein
the position information of each wireless terminal is calculated by triangulation method using distance information to adjacent two locations selected from those of other wireless terminals and the reference station.

12. A wireless terminal according to claim 11, wherein
the distance information is calculated in accordance with propagation loss of radio signals.

13. A wireless terminal according to claim 12, wherein
the propagation loss is calculated based on an ED (Energy Detect) value, which is a time-mean value of received signal strength.

14. A wireless terminal according to claim 12, wherein
each of the plurality of wireless terminals measures its output power and transmits the measured output power to other wireless terminals, and
each of the plurality of wireless terminals compensates a received signal strength in accordance with the output power transmitted from other wireless terminals.

15. A wireless terminal according to claim 9, wherein
the mesh network is of Zigbee.

16. A method for positioning wireless terminals in a mesh network, comprising:
providing a reference station having an absolute position information;
providing a plurality of wireless terminals, which are capable to communicate each other over a mesh network;
calculating position information of each wireless terminal using the absolute position information of the reference station;
storing the position information in each wireless terminal; and
sharing the position information among the plurality of wireless terminals.

17. A method for positioning wireless terminals in a mesh network according to claim 16, further comprising:
updating the position information of each wireless terminal at a predetermined timing,

18. A method for positioning wireless terminals in a mesh network according to claim 16, wherein
the position information of each wireless terminal is calculated by triangulation method using distance information to adjacent two locations selected from those of other wireless terminals and the reference station.

19. A method for positioning wireless terminals in a mesh network according to claim 18, wherein
the distance information is calculated in accordance with propagation loss of radio signals.

20. A method for positioning wireless terminals in a mesh network according to claim 19, wherein
the propagation loss is calculated based on an ED (Energy Detect) value, which is a time-mean value of received signal strength.

21. A method for positioning wireless terminals in a mesh network according to claim 19, further comprising:
measuring its output power in each wireless terminal;
transmitting the measured output power to other wireless terminals: and
compensating a received signal strength at each wireless terminal in accordance with the output power transmitted from other wireless terminals.

22. A method for positioning wireless terminals in a mesh network according to claim 16, wherein
the mesh network is of Zigbee.
